(19) United States
(12) Patent Application Publication
(10) Pub. No.: US 2020/0079135 A1
(43) Pub. Date: Mar. 12, 2020

(54) PLANNING AND ORGANIZING SYSTEM

(71) Applicant: Stephanie Garcia, Norwalk, CA (US)

(72) Inventor: Stephanie Garcia, Norwalk, CA (US)

(21) Appl. No.: 16/129,715

(22) Filed: Sep. 12, 2018

(51) Int. Cl. B42F 13/16; B42F 13/00; B42F 13/40

(52) U.S. Cl. CPC B42F 13/16; B42F 13/40; B42F 13/0033

(57) ABSTRACT

A comprehensive, all-in-one planning calendar and personal organizer structured and arranged to permit a user to be better organized, and to keep all their daily essentials from iPad® to smartphone to business-cards, files, flash drives, pens, petty cash and more in one easily carried, instantly accessible device.

### CROSS-REFERENCE TO RELATED APPLICATION

The present application is related to and claims priority from prior provisional application Ser. No. 62/557,745, filed Sep. 12, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of day planner and organizer devices and more specifically relates to a comprehensive, all-in-one planning calendar and personal organizer structured and arranged to permit a user to be better organized, and to keep all their daily essentials from iPad® to smartphone to business-cards, files, flash drives, pens, petty cash and more in one easily carried, instantly accessible device.

### 2. DESCRIPTION OF THE RELATED ART

Consider, for example, the need we all have to be organized in terms of time and space. Every day, we have things to do and people to see, and we need a way to keep everything straight, organized, accessible, and on time. To this end, we employ technology such as smartphones and tablets, personal and business calendars, and similar essential items and systems—usually carrying them in several places at once. Therefore, a need exists for a way to combine all these essentials and personal-organizing systems and devices.

Various attempts have been made to solve problems found in day planners and organizers art. Among these are found in: U.S. Pat. No. 6,390,712 to Daniel L. Urness; U.S. Pub. No. 2014/0308060 to Jeffrey Perry; and U.S. Pat. No. 4,794,711 to Richard A. Christensen. This prior art is representative of multiple compartment day planner and organizers.

None of the above inventions and patents, taken either singly or in combination, is seen to describe the invention as claimed. Thus, a need exists for a reliable My Assistant Planner, a comprehensive, all-in-one planning calendar and personal organizer structured and arranged to permit a user to be better organized, and to keep all their daily essentials from iPad® to smartphone to business-cards, files, flash drives, pens, petty cash and more in one easily carried, instantly accessible device and to avoid the above-mentioned problems.

### BRIEF SUMMARY OF THE INVENTION

In view of the foregoing disadvantages inherent in the known day planners and organizers art, the present invention provides a novel planning and organizing system. The general purpose of the present invention, which will be described subsequently in greater detail is to provide a comprehensive, all-in-one planning calendar and personal organizer structured and arranged to permit a user to be better organized, and to keep all their daily essentials from iPad® to smartphone to business-cards, files, flash drives, pens, petty cash and more in one easily carried, instantly accessible device. The features of the invention which are believed to be novel are particularly pointed out and distinctly claimed in the concluding portion of the specification. These and other features, aspects, and advantages of the present invention will become better understood with reference to the following drawings and detailed description.

The present invention holds significant improvements and serves as a planning and organizing system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

The figures which accompany the written portion of this specification illustrate embodiments and method(s) of use for the present invention, a planning and organizing system, constructed and operative according to the teachings of the present invention.

FIG. 1 shows a perspective view illustrating the planning and organizing system according to an embodiment of the present invention.

FIG. 2 is a perspective view illustrating a closed notebook of the planning and organizing system according to an embodiment of the present invention of FIG. 1.

FIG. 3 is a perspective view illustrating insert examples of the planning and organizing system according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a planning and organizing system constructed and operative according to the teachings of the present invention

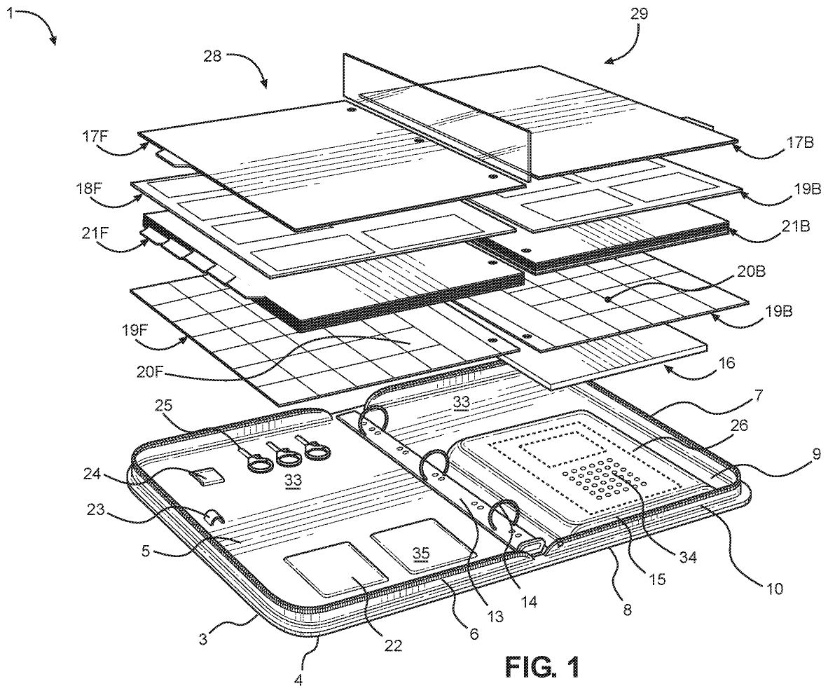

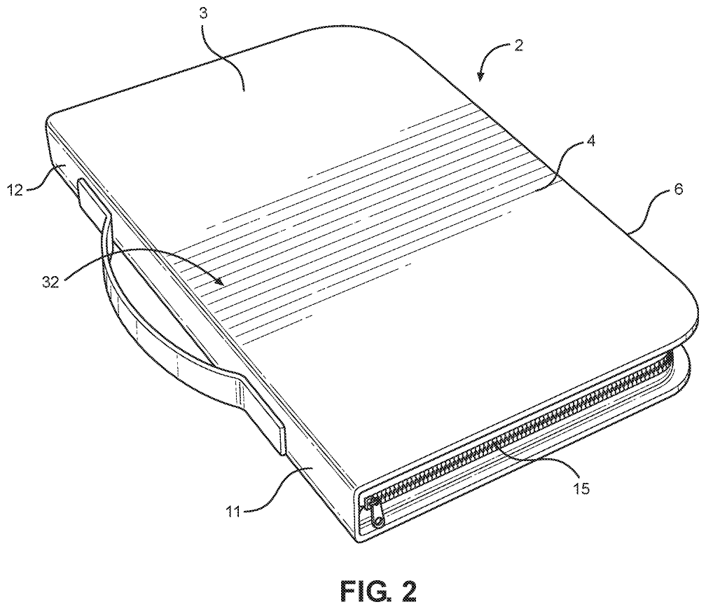

Referring to the drawings by numerals of reference there is shown in FIG. 1-3, a system for planning and organizing 1 comprising a notebook 2. The notebook 2 comprises a front cover 3 having an outer surface 4, an inner surface 5 and an outer edge 6. The notebook 2 also comprises a back cover 7 having an outer surface 8, an inner surface 9 and an outer edge 10.

The notebook 2 also comprises a spine 11 having an outer surface 12 and inner surface 13 and a plurality of spaced rings 14. The plurality of spaced rings 14 are attached to the inner surface 13 of the notebook 2 and are adapted to releasably hold sheets of paper 16, front file folders 17F and back file folders 17B, for holding documents for business and personal needs, front card holders 18F and back card holders 18B, for holding contacts for business and personal needs, a front calendar 19F and a back calendar 19B, for keeping track of business appointments and personal appointments, a front phone book 21F and a back phone book 21B, for keeping track of business contacts and personal contacts, and a front cash pocket 20F and a back cash pocket 20B for keeping business monies and personal money separate. The spine 11 is pivotally connected between the front cover 3 and back cover 7. Typically, there are three spaced rings 14.

The card holders 18F and 18B are formed of a flexible see-through material such as vinyl so that the writing on the cards can be clearly seen. The front cover 3 and the back cover 7 includes a vinyl material 32 and a padding material 33.

The notebook 2 also includes a releasable fastener 15. The releasable fastener 15 is connected between the outer edge 6 of the front cover 3 and the outer edge 10 of the back cover 7. The releasable fastener 15 is chosen from the group consisting of zippers, magnets and snap-clasp. The releasable fastener keeps the notebook closed when not in use and keeps any loose papers or cards from falling out.

The notebook 2 also includes a cell phone pocket 22 formed of a square piece of see-through vinyl with an open top which is attached to the inner surface 5 of the front cover 3 and which, by its see-through material will allow a user to manually access the screen and numeric pad of the cell phone. A pen/pencil holder 23 formed from a loop of elastic material capable of securely grasping a pen or pencil, a key holder 25 formed from a series of clip hangers or equivalent key holding construction, and a flash drive holder 24, formed as a small pocket of vinyl or other stretchy material capable of securely holding a flash drive, are also attached to the inner surface 5. Stretchy material is employed throughout the design of the notebook 2, where applicable, to allow for larger items of the same kind to be held. A computer holder 26 is attached to the inner surface 9 of the back cover 7 and is formed from an elastic material and includes padding 33 thereon. The computer holder 26 has a see-through vinyl surface which will allow a user to see and access a computer member 34 stored therein.

The computer member 34 is adapted to slidably fit within the open top of the computer holder 26. The computer member 34 is chosen from a list of computers consisting of a tablet, a smart phone and an IPAD. A computer component holder 35 is attached to the inner surface 5 of the front cover 3 and is formed of a see-through vinyl material with an open top which will allow a user to see and access and use a computer component 36 stored therein. The computer component 36 is adapted to slidably fit within the computer component holder 35. The computer component is chosen from a list consisting of a computer component charger and a computer component USB cable.

A rectangular divider member 27 formed from a rigid or semi-rigid material is adapted to be releasably held within the notebook 2 via the plurality of spaced rings 14 and is adapted to be a separating device to form a first notebook side 28 and a second notebook side 29 opposite from the first notebook side 28.

The first notebook side 28 includes a plurality of sheets of paper 16, a plurality of file folders 17, a plurality of card holders 18, one calendar 19 and one cash pocket 20. The first notebook side 28 is used for business purposes such as making appointments for office meetings, scheduling clients, booking business trips . . . etc.

The second notebook side 29 includes a plurality of sheets of paper 16, a plurality of file folders 17 a plurality of card holders 18, one calendar 19 and one cash pocket 20. The second notebook side 29 is used for personal purposes such as keeping up with sporting events for the children, making doctor's appointments, arranging a family vacation . . . etc.

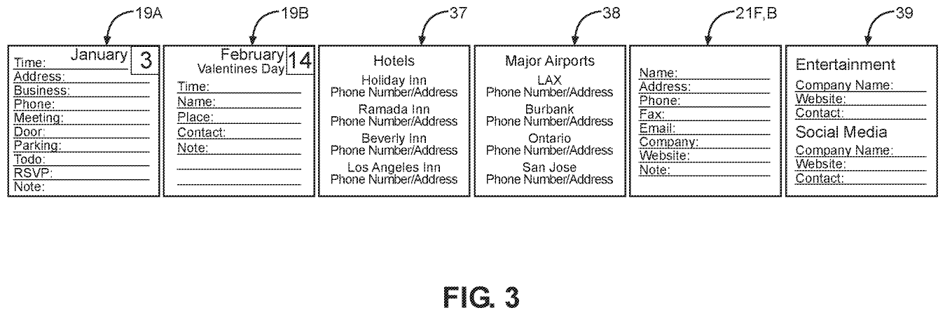

FIG. 3 illustrates insert examples that are indicative but not limited to lists that would be helpful for a busy person such as a business calendar 19A, Personal Calendar 19B, Contacts for Hotels 37, Contacts for Major Airports 38, Phone books both Personal and Business 21F and 21B respectively, and Entertainment/Social Media 39.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A system for planning and organizing comprising:
a notebook having
a front cover including
an outer surface;
an inner surface; and
an outer edge;
a back cover including
an outer surface;
an inner surface; and
an outer edge;
a spine including
an outer surface;
an inner surface; and
a plurality of spaced rings;
wherein the plurality of spaced rings are attached to the inner surface, and are adapted to releasably hold at least sheets of paper, file folders, card holders, calendars, and cash pockets on the plurality of spaced rings;
wherein the spine is pivotally connected between the front and back covers; and
a releasable fastener;
wherein the releasable fastener is connected between the outer edge of the front cover and the outer edge of the back cover;
sheets of paper;
wherein the sheets of paper are adapted to be releasably held within the notebook via said plurality of spaced rings;
at least one file folder;
wherein the at least one file folder is adapted to be releasably held within the notebook via the plurality of spaced rings;
at least one card holder;
wherein the at least one card holder is adapted to be releasably held within the notebook via the plurality of spaced rings;
at least one calendar;
wherein the at least one calendar is adapted to be releasably held within the notebook via the plurality of spaced rings;
at least one cash pocket;
wherein the at least one cash pocket is adapted to be releasably held within the notebook via the plurality of spaced rings;
at least one phonebook;
wherein the at least one phonebook is adapted to be releasably held within the notebook via the plurality of spaced rings;
at least one cell phone pocket;
wherein the at least one cell phone pocket is attached to the inner surface of the front cover;
at least one pen or pencil holder;
wherein the at least one pen or pencil holder is attached to the inner surface of front cover;
at least one flash drive holder;
wherein the at least one flash drive holder is attached to the inner surface of the front cover;
at least one key holder;
wherein the at least one key holder is attached to the inner surface of the front cover; and
at least one computer holder;
wherein the at least one computer holder is attached to the inner surface of the back cover;
a divider member;
wherein the divider member is adapted to be releasably held within the notebook via the plurality of spaced rings and is adapted to form a first notebook side and a second notebook side on opposite sides thereof;
a first notebook side including
a plurality of the sheets of paper;
a plurality of the file folders;
a plurality of the card holders;
one the calendar; and
one the cash pocket;
wherein one of the first notebook side is used for business purposes; and
a second notebook side including
a plurality of the sheets of paper;
a plurality of the file folders;
a plurality of the card holders;
one the calendar; and
one the cash pocket;
wherein one of the second notebook side is used for personal purposes.

2. (canceled)

3. The system for planning and organizing of claim 1, wherein the at least one card holder is formed from a flexible material.

4. A system for planning and organizing comprising:
a notebook having
a front cover including
an outer surface;
an inner surface; and
an outer edge;
a back cover including
an outer surface;
an inner surface; and
an outer edge;
a spine including
an outer surface;
an inner surface; and
a plurality of spaced rings;
wherein the plurality of spaced rings are attached to the inner surface, and are adapted to releasably hold at least sheets of paper, file folders, card holders, calendars, and cash pockets on the plurality of spaced rings;
wherein the spine is pivotally connected between the front and back covers; and
a releasable fastener;
wherein the releasable fastener is connected between the outer edge of the front cover and the outer edge of the back cover;
sheets of paper;
wherein the sheets of paper are adapted to be releasably held within the notebook via said plurality of spaced rings;
at least one file folder;
wherein the at least one file folder is adapted to be releasably held within the notebook via the plurality of spaced rings;
at least one card holder;
wherein the at least one card holder is adapted to be releasably held within the notebook via the plurality of spaced rings;
at least one calendar;
wherein the at least one calendar is adapted to be releasably held within the notebook via the plurality of spaced rings;
at least one cash pocket;
wherein the at least one cash pocket is adapted to be releasably held within the notebook via the plurality of spaced rings;
at least one phonebook;
wherein the at least one phonebook is adapted to be releasably held within the notebook via the plurality of spaced rings;
at least one cell phone pocket;
wherein the at least one cell phone pocket is attached to the inner surface of the front cover;
at least one pen or pencil holder;
wherein the at least one pen or pencil holder is attached to the inner surface of the front cover;
at least one flash drive holder;
wherein the at least one flash drive holder is attached to the inner surface of the front cover;
at least one key holder;
wherein the at least one key holder is attached to the inner surface of the front cover; and
at least one computer holder;
wherein the at least one computer holder is attached to the inner surface of the back cover, and
wherein said outer surfaces of said front cover and said back cover includes a vinyl material and a padding material.

5. The system for planning and organizing of claim 1, wherein there are three of the spaced rings.

6. The system for planning and organizing of claim 1, wherein the releasable fastener is formed as a zipper.

7. The system for planning and organizing of claim 1, wherein the releasable fastener includes magnets.

8. The system for planning and organizing of claim 1, wherein the releasable fastener is formed as a snap-clasp.

9. The system for planning and organizing of claim 1, wherein the at least one computer holder is formed from an elastic material and includes a padding material on a surface of the elastic material.

10. The system for planning and organizing of claim 1, wherein the notebook further comprises a computer member adapted to slidably fit within the computer holder.

11. The system for planning and organizing of claim 10, wherein computer member is chosen from a list of computer members consisting of a tablet and a smart phone.

12. The system for planning and organizing of claim 1, wherein the notebook further comprises at least one computer component holder attached to the inner surface of the front cover.

13. The system for planning and organizing of claim 12, wherein the notebook further comprises computer component members adapted to slidably fit within the computer component holder.

14. The system for planning and organizing of claim 10, wherein the computer component members are chosen from a list of computer component members consisting of a computer component charger cable, and a computer component USB cable.

15. The system for planning and organizing of claim 4, wherein the at least one card holder is formed from a flexible material.

16. The system for planning and organizing of claim 4, wherein the notebook further comprises at least one computer component holder attached to the inner surface of the front cover.

17. The system for planning and organizing of claim 4, wherein there are three of the spaced rings.

18. The system for planning and organizing of claim 4, wherein the releasable fastener is formed as a zipper.

19. The system for planning and organizing of claim 4, wherein the releasable fastener includes magnets.

20. The system for planning and organizing of claim 4, wherein the releasable fastener is formed as a snap-clasp.

21. The system for planning and organizing of claim 4, wherein the at least one computer holder is formed from an elastic material and includes a padding material on a surface of the elastic material
